(19) United States
(12) Patent Application Publication
(10) Pub. No.: US 2006/0203850 A1
(43) Pub. Date: Sep. 14, 2006

(54) Method and apparatus for distributing timing information in an asynchronous wireless communication system

(76) Inventors: Walter L. Johnson, Hoffman Estates, IL (US); Timothy J. Wilson, Rolling Meadows, IL (US)

Correspondence Address: MOTOROLA, INC., 1303 EAST ALGONQUIN ROAD, IL01/3RD, SCHAUMBURG, IL, 60196, US

(21) Appl. No.: 11/079,676

(22) Filed: Mar. 14, 2005

(51) Int. Cl. H04Q 7/00; H04Q 7/24; H04J 3/06

(52) U.S. Cl. 370/503; 370/328; 370/338

(57) ABSTRACT

An Access Point (AP) receives a first set of timing information comprising timing information for at least one neighboring AP and conveys, to a user equipment (UE), a second set of timing information comprising timing information for the at least one neighboring AP, wherein the second set of timing information is derived from the first set of timing information. Based on the second set of timing information, the UE is able to determine a time to scan the at least one neighboring AP. In various embodiments of the present invention, the AP may receive the first set of timing information from another UE or may receive the timing information without the involvement of the another UE, for example, via a network interconnecting the APs or by monitoring an air interface of the at least one neighboring AP.

### FIELD OF THE INVENTION

The present invention relates generally to asynchronous wireless communication systems, such as wireless local area networks, and in particular, to a provision of timing information within an asynchronous wireless communication system.

### BACKGROUND OF THE INVENTION

Local area networks (LANs) allow organizations to share information over a high speed network that may be assembled with relatively inexpensive hardware components. LANs also provide for relatively inexpensive hardware connections to networks beyond the LAN by allowing multiple users within the LAN to connect to each of multiple networks outside of the LAN through an interface common to all users. Until recently, LANs were limited to hardwired infrastructure, requiring the user to physically connect to the LAN via a wired connection. However, with the recent growth of wireless telephony and wireless messaging, wireless communications have also been applied to the realm of LANs, resulting in the development of wireless local area networks (WLANs).

In a WLAN, each Access Point (AP) announces its presence to user equipment (UEs) that have roamed into, or activated in, the AP's coverage area by broadcasting a beacon. When a user equipment (UE) wishes to access the WLAN, the UE must first establish and configure a link with an AP, typically by actively or passively scanning beacons of the WLAN. In addition, based on the scan, the UE builds a scanning list comprising beacons associated with neighboring Access Points (APs), which beacons are subsequently periodically scanned by the mobile station in order to facilitate a handoff.

In an active scan, a UE initiates the establishment and configuration of a wireless link by broadcasting a Probe Request. The Probe Request includes a Service Set Identifier (SSID) and data rates supported by the UE. Upon receiving the Probe Request, each AP determines whether the SSID included in the Probe Request is the same as an SSID associated with the AP. When the SSIDs are the same, the AP responds to the Probe Request by transmitting a Probe Response back to the UE that includes, among other things, the SSID associated with the AP, capabilities supported by the AP, and beacon timing information. Based on the received Probe Responses, the UE selects a best AP and associates with the selected AP.

In a passive scan, instead of utilizing the Probe Request and Probe Response to initiate communication with an AP, the UE scans beacons that are periodically transmitted by the APs. Each beacon includes capabilities supported by the AP and beacon timing information and may further include an SSID associated with the AP. Based on the scanned beacons, the UE builds a scanning list comprising information related to the scanned beacons. The UE may further select an AP and associate with the selected AP.

WLANs are asynchronous communication systems. That is, in a WLAN, a timing of a broadcast of a beacon by each AP is independent of a timing of a broadcast of a beacon by the other APs. Neither a UE activating in, or roaming into, a WLAN nor the APs of the WLAN have a priori knowledge of the beacon schedules (other than a schedule of an AP's own beacon). As a result, when performing a passive scan of an AP, the UE must continuously scan an air interface of the AP in order to receive the AP's beacon. The UE then obtains timing information associated with each individual beacon on an AP-by-AP, that is, a beacon-by-beacon, basis. Thus building a scanning list can consume an excessive amount of time and an inordinate amount of power sourced by a limited life battery.

For example, an AP typically transmits a beacon every 100 milliseconds (ms). When a UE begins a scan of an AP right after the AP has transmitted its beacon, the UE will then have to scan for nearly 100 ms before capturing the beacon. In addition, UEs typically scan one beacon at a time. Assuming a time interval between beacons of 100 ms, or an average scanning time of 50 ms per beacon (that is, per AP), the total scanning time can quickly add up as a UE initially scans all neighboring beacons in order to build up a scanning list. While active scanning is quicker, active scanning is not permitted in many bands and in many regulatory domains. For example, in Europe, active scanning is not permitted in some frequencies associated with WLAN networks due to the potential for interference with military radar systems.

Therefore a need exists for a method and apparatus that permits a user of a UE accessing a WLAN to obtain timing information for neighboring beacons without the need to continuously scan the WLAN until all beacons have been acquired.

### BRIEF DESCRIPTION OF THE DRAWINGS

FIG. 1 is a block diagram of an asynchronous wireless communication system in accordance with an embodiment of the present invention.

FIG. 2 is a block diagram of an Access Point of FIG. 1 in accordance with an embodiment of the present invention.

FIG. 3 is a block diagram of a User Equipment of FIG. 1 in accordance with an embodiment of the present invention.

FIG. 4 is a logic flow diagram of a method executed by the communication system of FIG. 1 in distributing beacon timing information in accordance with various embodiments of the present invention.

FIG. 5 is a timing diagram of beacon transmissions by the Access Points of FIG. 1 that compares beacon acquisition by a User Equipment without utilizing beacon timing information with beacon acquisition by a User Equipment that utilizes beacon timing information.

### DETAILED DESCRIPTION OF THE INVENTION

To address the need for a method and apparatus that permits a user of a user equipment (UE) accessing a Wireless Local Area Network (WLAN) to obtain timing information for neighboring beacons without the need to continuously scan the WLAN until all beacons have been acquired, an Access Point (AP) is provided that receives a first set of timing information comprising timing information for at least one neighboring AP and conveys, to the UE, a second set of timing information comprising timing information for the at least one neighboring AP, wherein the second set of timing information is derived from the first set of timing information. Based on the second set of timing information, the UE is able to determine a time to scan the at least one neighboring AP. In various embodiments of the present invention, the AP may receive the first set of timing information from another UE or may receive the first set of timing information without the involvement of the another UE, for example, via a network interconnecting the APs or by monitoring an air interface of the at least one neighboring AP.

Generally, an embodiment of the present invention encompasses a method for distributing timing information, the method including receiving, by an AP, a first set of timing information comprising timing information for at least one neighboring AP and conveying, by the AP to a UE, a second set of timing information comprising timing information for the at least one neighboring AP, wherein the second set of timing information is derived from the first set of timing information.

Another embodiment of the present invention encompasses a wireless user equipment comprising a processor configured to receive a set of timing information from an AP comprising timing information for a different, neighboring AP and to determine a time to scan the different, neighboring AP based on the received set of timing information.

Yet another embodiment of the present invention encompasses an AP comprising a processor configured to receive a first set of timing information comprising timing information for at least one neighboring AP and to convey, to a UE, a second set of timing information comprising timing information for the at least one neighboring AP, wherein the second set of timing information is derived from the first set of timing information.

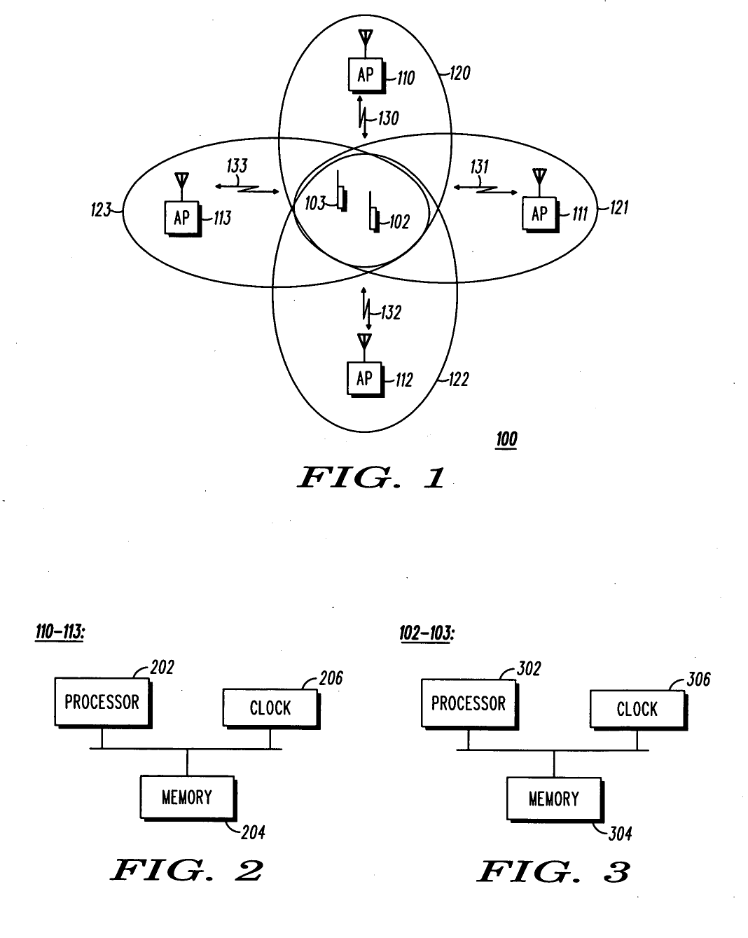

The present invention may be more fully described with reference to FIGS. 1-5. FIG. 1 is a block diagram of a wireless communication system 100 in accordance with an embodiment of the present invention. Wireless communication system includes multiple Access Points (APs) 110-113 (four shown) that each provides access to a network (not shown). The network may provide direct interconnections among the APs 110-113 and/or may provide interconnections among the APs 110-113 via intermediate network elements (not shown), such as Mobile Switching Centers (MSCs), gateways, and/or management servers, as is known in the art. Each AP 110-113 provides wireless communication services to user equipment (UEs) located in a respective coverage area 120-123 serviced by the AP via a respective air interface 130-133. Communication system 100 further includes multiple wireless UEs 102, 103 (two shown), such as but not limited to a cellular telephone, a radiotelephone, or a wireless modem that is included in or coupled to data terminal equipment, such as a personal computer, a laptop computer, a workstation, a printer, or a facsimile machine, that is capable of operating in a WLAN communication system.

Referring now to FIG. 2, each AP 110-113 includes a processor 202, such as one or more microprocessors, microcontrollers, digital signal processors (DSPs), combinations thereof or such other devices known to those having ordinary skill in the art, which processor is configured to execute the functions described herein as being executed by the AP. Each AP 110-113 further includes at least one memory device 204 associated with processor such as random access memory (RAM), dynamic random access memory (DRAM), and/or read only memory (ROM) or equivalents thereof, that store data and programs that may be executed by the processor and that allow the AP to perform all functions necessary to operate in communication system 100. Each AP 110-113 additionally includes a clock 206 coupled to processor 202 that counts time to determine when a target transmission time, for example, a Target Beacon Transmission Time (TBTT) of a beacon that is transmitted by the AP, is to occur.

At least one memory device 204 maintains a service provider identifier or network identifier, preferably a Service Set Identifier (SSID), associated with the AP, for example, AP 110, and further maintains a service provider identifier or a network identifier associated with each neighbor AP, for example, APs 111-113. At least one memory device 204 further maintains a record of capabilities of the AP and services supported by the AP, such as data rates, modulation types, band classes, and encryption schemes supported by the AP, timing information associated with a transmission of a beacon by the AP, and instructions for processing signals that are exchanged by the AP and UEs 102 and 103.

The beacon timing information comprises information that permits the AP, and more particularly processor 202 of the AP, to determine when to transmit a beacon. For example, in an 802.11 Wireless Local Area Network (WLAN) communication system, the timing information includes a value for clock 206 and a Beacon Interval value (typically 100*1024, or 102,400, microseconds (μs)). Based on a count of clock 206, processor 202 determines a timer value, that is, TSF Timer (in μs), associated with the current count. For each timer value (TSF Timer), processor 202 further calculates a value based on the formula ‘TSF Timer mod Beacon Interval.’ When the value of ‘TSF Timer mod Beacon Interval’ is equal to zero, the AP, that is, processor 202 of the AP, transmits a beacon. If or when clock 206 reaches a maximum value, then clock 206 rolls over and resumes counting.

Referring now to FIG. 3, each UE 102, 103 includes a processor 302, such as one or more microprocessors, microcontrollers, digital signal processors (DSPs), combinations thereof or such other devices known to those having ordinary skill in the art, which processor is configured to execute the functions described herein as being executed by the UE. Each UE 102, 103 further includes at least one memory device 304 associated with processor such as random access memory (RAM), dynamic random access memory (DRAM), and/or read only memory (ROM) or equivalents thereof, that store data and programs that may be executed by the processor and that allow the UE to perform all functions necessary to operate in communication system 100. At least one memory device 304 maintains a UE identifier that is uniquely associated with the UE and a service provider identifier or network identifier, preferably a Service Set Identifier (SSID), associated with each service provider subscribed to by UE 102 and operating using the APs 110-113 of communication system 100. At least one memory device 304 further maintains a record of capabilities of the UE and services supported by the UE, such as data rates, modulation types, band classes, and encryption schemes supported by the UE, and instructions for processing messages that are exchanged by the UE and APs 110-113. Each UE 102, 103 further includes a clock 306.

The embodiments of the present invention preferably are implemented within each of APs 110-113 and UEs 102, 103, and more particularly with or in software programs and instructions stored in the at least one memory devices 204, 304 and executed by the processors 202, 302 of the APs and UEs. However, one of ordinary skill in the art realizes that the embodiments of the present invention alternatively may be implemented in hardware, for example, integrated circuits (ICs), application specific integrated circuits (ASICs), and the like, such as ASICs implemented in one or more of APs 110-113 and UEs 102, 103. Based on the present disclosure, one skilled in the art will be readily capable of producing and implementing such software and/or hardware without undo experimentation.

Communication system 100 comprises an asynchronous wireless communication system. That is, a timing of a broadcast of a beacon by each AP 110-113 is independent of a timing of a broadcast of a beacon by each of the other APs. Preferably, communication system 100 is a WLAN communication system that operates in accordance with the Institute for Electrical and Electronic Engineers (IEEE) 802.11 standards for WLAN communication systems, which standards are hereby incorporated herein in their entirety and are available from the IEEE administrative offices in Piscataway, N.J., or on-line at standards.ieee.org. However, one of ordinary skill in the art realizes that communication system 100 may operate in accordance with any asynchronous wireless communication standard, such as any of the IEEE 802.xx standards, for example, the 802.15, 802.16, or 802.20 standards, or the Universal Mobile Telecommunication Service (UMTS) communication system standards.

In order to permit a user of a UE, such as UE 103, accessing communication system 100 or roaming among the APs of communication system 100 to obtain timing information for multiple APs of the communication system, such as APs 110-113, without the need to continuously scan the communication system until all signals of all such APs have been acquired, communication system 100 provides for a collection of such timing information by one AP of the multiple APs and for a distribution of the collected timing information by the one AP to all UEs in communication with the AP.

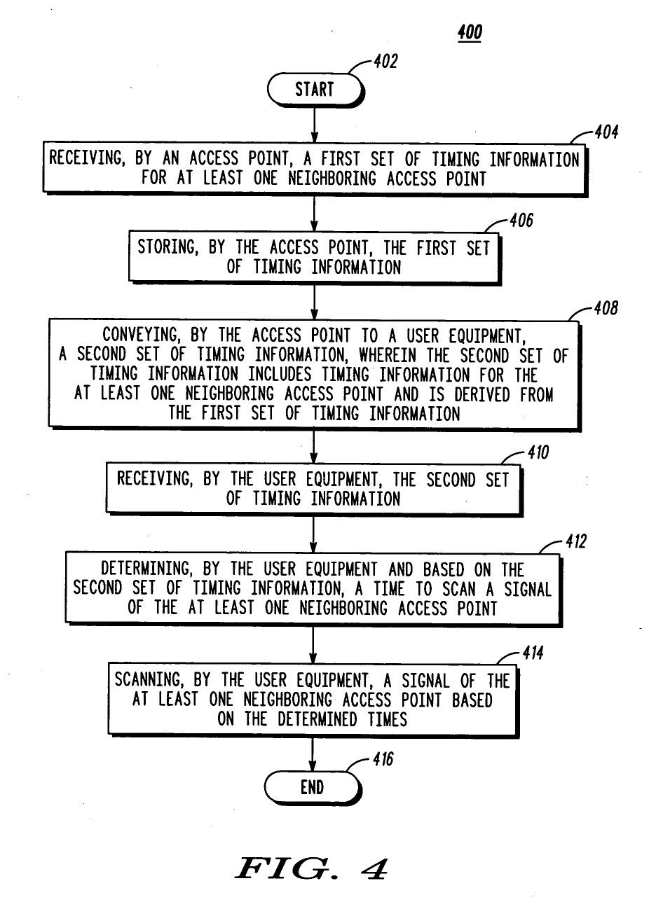

FIG. 4 is a logic flow diagram 400 of a method executed by communication system 100 in distributing timing information in accordance with various embodiments of the present invention. Logic flow diagram 400 begins (402) when an AP, such as AP 110, receives (404) a first set of timing information concerning at least one neighboring AP, such as one or more of APs 111-113. Preferably the first set of timing information comprises timing information associated with a transmission of a beacon by the at least one neighboring AP. However, one of ordinary skill in the art realizes that the timing information may concern any one of a variety of signaling signals, typically frames, that is transmitted by each of the at least one neighboring AP, such as a beacon frame that includes a Traffic Indication Map (TIM) that is described in the IEEE 802.11 standards or a Measurement frame that has been proposed to the IEEE 802.11 standards. The timing information included in the first set of timing information is information that may be used by a UE to predict a time of a transmission of the signaling signal/frame, such as a beacon, by the at least one neighboring AP 111-113.

AP 110 may receive the timing information for the at least one neighboring AP 111-113 from a first UE, such as UE 102, serviced by AP 110 or from the at least one neighboring AP 111-113 without the intervention of a UE, for example, via the network interconnecting the APs 110-113 or by AP 110 monitoring the air interface 131-133 of the at least one neighboring AP 111-113. In the former instance, the first UE, that is UE 102, may autonomously collect the timing information and convey the timing information to AP 110 or may collect the timing information and convey the timing information to AP 110 in response to receiving an instruction from the AP. For example, UE 102, may autonomously collect the timing information by performing a passive scan of beacons of each of APs 110-113 when the UE roams into, or activates in, communication system 100. That is, in response to roaming into, or activating in, communication system 100, UE 102 scans for beacons transmitted by the APs 110-113. A beacon transmitted by each AP 110-113 includes a service provider identifier or network identifier associated with the AP, such as an SSID, capabilities supported by the AP, and beacon timing information associated with the AP, such as a current count of clock 206 of the AP, for example, a TSF Timer value, and the AP's Beacon Interval value.

In response to acquiring a beacon from each AP of the multiple APs 110-113, UE 102 stores, in at least one memory device 304, the information included in the beacon in correspondence with the AP transmitting the beacon. In addition, based on the acquired beacons, the UE builds, and stores in at least one memory device 304 of the UE, a scanning list comprising information related to the scanned beacons. The UE may further select an AP, such as AP 110, from among the multiple scanned APs 110-113, associate to the selected AP, and join the network via the selected AP. In this sense, the UE may be considered associated to the selected AP, that is, AP 110.

By way of another example, UE 102 may autonomously collect the timing information by performing an active scan of APs 110-113. That is, in response to roaming into, or activating in, commununication system 100, UE 102 broadcasts a Probe Request. The Probe Request includes a service provider or network identifier maintained by the UE, preferably an SSID, and data rates supported by the UE. Upon receiving the Probe Request, each AP 110-113 determines whether the service provider/network identifier included in the Probe Request is the same as a service provider/network identifier associated with the AP. When the service provider/network identifiers are the same, the AP responds to the Probe Request by transmitting a Probe Response back to UE 102 that includes, among other things, the service provider/network identifier associated with the AP, capabilities supported by the AP, and beacon timing information.

Similar to the passive scan, in response to receiving each Probe Response, UE 102 stores, in at least one memory device 304 of the UE, the timing information included in the Probe Response in correspondence with the AP transmitting the beacon. In addition, based on the received Probe Responses, UE 102 builds, and stores in at least one memory device 304 of the UE, a scanning list comprising information related to the received Probe Responses. UE 102 may further select a best AP, such as AP 110, from among the multiple responding APs 110-113, associate to the selected AP, and join the network via the selected AP.

By way of yet another example, AP 110 may instruct UE 102 to collect beacon timing information for neighboring APs, such as APs 111-113, by conveying a Beacon Request to the UE. The Beacon Request may request that the UE scan (passive or active), that is, listen to, beacons of neighboring APs and collect, and report back, beacon timing information associated with each of neighboring APs 111-113.

In response to collecting the timing information from the at least one neighboring AP 111-113, UE 102 reports a first set of timing information, comprising timing information for each of the at least one neighboring APs 111-113, back to associated AP 110. Preferably, the first set of timing information comprises the timing information collected by UE 102 from each of the neighboring APs 11 1-113. For example, UE 102 may report the first set of timing information back to AP 110 in one or more Beacon Reports. In one embodiment of the present invention, UE 102 may report the first set of timing information to associated AP 110 on an AP-by-AP, that is, beacon-by-beacon, basis. In such an embodiment, the UE may separately report the timing information collected from each neighbor AP, which report further identifies the AP associated with the timing information. In another embodiment of the present invention, UE 102 may report the timing information on a lump-sum basis. That is, UE 102 may collect the timing information for all neighboring APs in at least one memory device 304 and then convey the collected information back in a single report. Preferably, in the report, the timing information collected for each of the at least one APs 111-113 is associated with the corresponding AP.

As noted above and with respect to step 404, instead of receiving the timing information for the at least one neighboring AP 111-113 via a UE, such as UE 102, AP 110 may receive the timing information for the at least one neighboring AP 111-113 from the at least one neighboring AP without the involvement of the UE. For example, each of the multiple APs 110-113 may be directly or indirectly interconnected with each other AP of the multiple APs via the network. As a result, each AP 110-113 may share the AP's timing information with each of the other APs via the interconnecting network, which sharing may be unprompted or may be in response to a receipt of a request from an AP for such timing information. By way of another example, each AP 110-113 may autonomously monitor the air interfaces 130-133 of the other APs and acquire signaling signals, such as the beacons, of the other APs, thereby obtaining the timing information via such monitored signals in the same way that a UE, such as UE 102, obtains timing information by scanning the signals of such APs.

In response to receiving the first set of timing information (404), associated AP 110 stores (406) the first set of timing information in the at least one memory device 204 of the AP and in addition stores the timing information for each neighboring AP 111- 113 in correspondence with that AP. AP 110 then conveys (408) a second set of timing information to a second UE, such as UE 103, which second set of timing information is derived from the first set of timing information and which second set of timing information includes timing information that may be used by the second UE, that is, UE 103, to predict a time of a transmission of a signaling signal, for example, a frame such as a beacon, by the at least one neighboring AP 111-113. The second set of timing information may further include AP 110's own timing information. For example, if second UE 103 is already associated to AP 110, then the UE may already have the timing information of AP 110 and there may be no need to re-convey AP 110's timing information. However, if second UE 103 is not associated to AP 110, then it may be desirable to include, in the second set of timing information, the timing information of AP 110 in addition to the timing information of the at least one neighboring AP 111-113.

In one embodiment of the present invention, the second set of timing information may include a current clock count (TSF Timer value) and a Beacon Interval value for each AP of the neighboring APs 111-113 and, when appropriate, for associated AP 110. In another embodiment of the present information, the second set of timing information may comprise relative timing information for each neighboring AP (relative, for example, to the timing information of another AP, that is, AP 110) that corresponds to a time elapsing until a next beacon will be transmitted by the neighboring AP. For example, the second set of timing information may comprise, for at least one neighboring AP 111-113, an offset value, such as a Neighbor TBTT (Target Beacon Transmit Time) Offset value or a TSF Offset value, that provides a timing offset relative to the timing of another AP (for example, AP 110). In such an embodiment, the second set of timing information may further comprise each AP's Beacon Interval value. The offset value may be calculated by AP 110 based on the timing information received by AP 110 for each of the at least one neighboring AP, or the offset value may be calculated by the UE collecting the timing information, that is, UE 102, and then conveyed by the UE to AP 110 as part of the first set of timing information. In other embodiments of the present invention, the first and second sets of timing information may further include any other information that a second UE, that is, UE 103, may deem helpful in order to determine when to scan the signaling signals/frames of the at least one neighboring AP, such as aging information related to an age of the timing information-related values for each of the at least one neighboring AP or a time stamp value of when the timing information was valid.

AP 110 may convey the second set of timing information to UE 103 autonomously or in response to a request by the UE. For example, AP 110 may periodically broadcast the second set of timing information for each of APs 110-113 or may autonomously convey the second set of timing information to UE 103 at any time during or after the UE associates with the AP. The second set of timing information may be so conveyed or broadcast in a modified version of a Neighbor Report element, which Neighbor Report element is modified to include, in a Neighbor List entry data field, beacon timing information associated with each AP of neighboring APs 111-113 along with beacon timing information for the conveying AP, that is, AP 110. By way of yet other examples, in response to receiving a Probe Request, an Association Request, or a Neighbor Report Request from UE 103, AP 110 respectively may convey the second set of timing information for APs 110-113 to the UE in a modified version of a Probe Response, a modified version of an Association Response, or a modified version of a Neighbor Report Response, which messages are modified to include a data field comprising the second set of timing information.

In response to receiving (410) the second set of timing information from AP 110, UE 103 may determine (412) a time to scan a signaling signal/frame, preferably a beacon, associated with the at least one neighboring AP 111-113 based on the second set of timing information, as well as a time to scan a signaling signal/frame of AP 110 when the second set of timing information further includes timing information for AP 110. UE 103 may then scan (414), and acquire, the signaling signal, preferably beacon, of the at least one neighboring AP 110-113 (and, when appropriate, AP 110) at the determined times. Logic flow 400 then ends (416). By determining a time to scan a signal such as a beacon of each of multiple APs 110-113 based on the second set of timing information received from a single AP, that is, AP 110, UE 103 is able to perform a much more efficient scan than in the prior art, resulting in an expedited scan and further saving power and preserving battery life.

Further, based on the timing information received from AP 110, UE 103 may determine to not scan other neighboring APs (not shown) whose timing information is not included in the second set of timing information. Such other neighboring APs may be down or otherwise not operating or not exist and, as a result, may not be transmitting a signaling signal/frame. For example, it may be due to such non-transmissions that UE 102 does not collect timing information for such other neighboring APs and therefore does not include such timing information in the first set of timing information conveyed by UE 102 to AP 110. By not scanning such other neighboring APs, UE 103 saves power that otherwise would be consumed in fruitless scans of such APs.

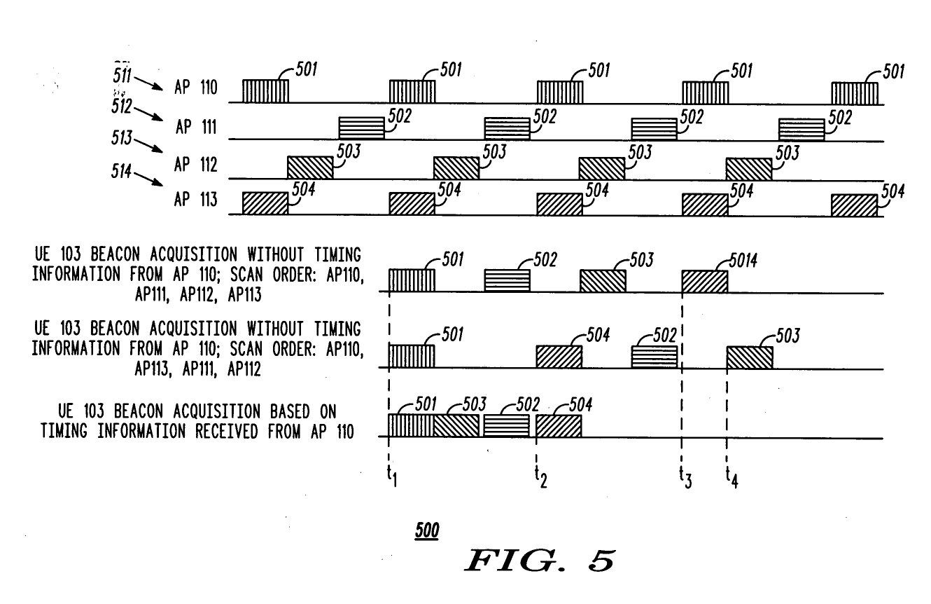

For example, FIG. 5 is a timing diagram 500 comparing scans by a UE, such as UE 103, of beacons associated with multiple APs, such as APs 110-113, without having received beacon timing information for the multiple APs with a scan by the UE based on received beacon timing information for the multiple APs. In each scan depicted in FIG. 5, the UE is constrained by the fact that it may scan- for only one beacon at a time. A first four timelines 511-514 of timing diagram 500 depicts a respective, periodic transmission of a beacon 501-504 by each of the multiple APs, that is, APs 110-113. A fifth timeline 515 depicts a scan by a UE, such as UE 103, of beacons 501-504 without knowledge of the scheduling of each beacon. As a result, the UE scans, and acquires, the beacons in a random order, acquiring a first beacon, that is, beacon 501, at a time ti and acquiring a last beacon, that is, beacon 504, at a time t₃. In timeline 515, the UE ends up scanning the beacons of APs 110, 111, 112, and 113 in that order. A sixth timeline 516 also depicts a scan by a UE, such as UE 103, of beacons 501-504 without knowledge of the scheduling of each beacon. As a result, UE 103 again scans the beacons in a random order, acquiring a first beacon, that is, beacon 501, at a time ti and acquiring a last beacon, that is, beacon 503, at a time t₄. In timeline 516, the UE ends up scanning the beacons of APs 110, 113, 111, and 112 in that order. One may note that in order to scan for a beacon of each AP of APs 110-113, UE 103 may have to stay awake for as long as a full beacon interval as the UE does not know exactly when a beacon will be transmitted.

In a seventh timeline 517, a UE, such as UE 103, is aware of the scheduling of the beacons of the multiple APs 110-113 based on beacon timing information received from one of the multiple APs, such as AP 110. As a result, the UE is able to scan the APs in an optimal order, that is, AP 110, AP 112, AP 111, and AP 113. Again, the UE acquires a first beacon, that is, beacon 501, at a time ti but now the UE acquires a last beacon, that is, beacon 504, at a time t₂. As is apparent from timing diagram 500, t₂<t₃<t₄. In addition, by scanning the beacons at transmission times based on beacon timing information received from one of the multiple APs, the UE is able to sleep between the transmission times, waking up in time to scan each successive beacon at the determined transmission time and thereby conserving power and battery life.

By providing to UE 103, via AP 110, timing information for a signaling signal/frame for at least one neighboring AP 111-113, UE 103 is able to determine a time of transmission of the signaling signal/frame by the at least one neighboring AP. The UE may then scan the at least one neighboring AP for the signaling signal/frame at the determined time. By scanning the at least one neighboring AP only at the determined time instead of continuously scanning the AP until the signaling signal/frame, is acquired, UE 103 is able to sleep until the determined time, thereby conserving battery life. In addition, based on the timing information received from AP 110, UE 103 may determine to not scan APs whose timing information is not included in such timing information, thereby avoiding scanning APs that are currently not transmitting, are dead, or are non-existent, and further conserving battery life.

While the present invention has been particularly shown and described with reference to particular embodiments thereof, it will be understood by those skilled in the art that various changes may be made and equivalents substituted for elements thereof without departing from the scope of the invention as set forth in the claims below. Furthermore, one of ordinary skill in the art realizes that the components and operations of the communication system detailed herein are not intended to be exhaustive but are merely provided to enhance an understanding and appreciation for the inventive principles and advantages of the present invention, rather than to limit in any manner the invention. Accordingly, the specification and figures are to be regarded in an illustrative rather then a restrictive sense, and all such changes and substitutions are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus. Furthermore, unless otherwise indicated herein, the use of relational terms, if any, such as first and second, top and bottom, and the like are used solely to distinguish one entity or action from another entity or action without necessarily requiring or implying any actual such relationship or order between such entities or actions.

What is claimed is:

1. A method for distributing timing information comprising:
receiving, by an Access Point, a first set of timing information comprising timing information for at least one neighboring Access Point; and
conveying, by the Access Point to a user equipment, a second set of timing information comprising timing information for the at least one neighboring Access Point, wherein the second set of timing information is derived from the first set of timing information.

2. The method of claim 1, wherein the second set of timing information further comprises timing information for the Access Point.

3. The method of claim 1, wherein the first set of timing information and the second set of timing information each comprises timing information for a signal that is transmitted by the at least one neighboring Access Point and whose transmission may be predicted based on the timing information.

4. The method of claim 3, wherein the first set of timing information and the second set of timing information each comprises beacon timing information.

5. The method of claim 1, wherein the user equipment comprises a second user equipment and wherein receiving comprises receiving, by an Access Point from a first user equipment, a first set of timing information comprising timing information for at least one neighboring Access Point

6. The method of claim 5, further comprising:
collecting, by the first user equipment, timing information from the at least one neighboring Access Point; and
conveying, by the first user equipment to the Access Point, the first set of timing information, wherein the first set of timing information is derived from the timing information collected by the user equipment from the at least one neighboring Access Point.

7. The method of claim 6, wherein collecting comprises autonomously collecting, by the first user equipment, the first set of timing information.

8. The method of claim 6, wherein collecting comprises:
receiving, by the first user equipment, a request for the timing information; and
in response to receiving the request, collecting, by the first user equipment, timing information from the at least one neighboring Access Point.

9. The method of claim 1, wherein receiving comprises receiving, by the Access Point, the first set of timing information from the at least one neighboring Access Point without an involvement of a user equipment.

10. The method of claim 1, further comprising:
receiving, by the user equipment, the second set of timing information; and
determining, by the user equipment, a time to scan the at least one Access Point based on the second set of timing information.

11. A wireless user equipment comprising a processor configured to receive a set of timing information from an Access Point comprising timing information for a different, neighboring Access Point and to determine a time to scan the different, neighboring Access Point based on the received set of timing information.

12. The wireless user equipment of claim 11, wherein the set of timing information further comprises timing information for the Access Point.

13. The wireless user equipment of claim 11, wherein the set of timing information comprises timing information for a signal that is transmitted by the at least one neighboring Access Point and whose transmission may be predicted based on the timing information.

14. The wireless user equipment of claim 11, wherein the set of timing information comprises beacon timing information.

15. An Access Point comprising a processor configured to receive a first set of timing information comprising timing information for at least one neighboring Access Point and to convey, to a user equipment, a second set of timing information comprising timing information for the at least one neighboring Access Point, wherein the second set of timing information is derived from the first set of timing information.

16. The Access Point of claim 15, wherein the second set of timing information further comprises timing information for the Access Point.

17. The Access Point of claim 15, wherein the first set of timing information and the second set of timing information each comprises timing information for a signal that is transmitted by the at least one neighboring Access Point and whose transmission may be predicted based on the timing information.

18. The Access Point of claim 17, wherein the first set of timing information and the second set of timing information each comprises beacon timing information.

19. The Access Point of claim 15, wherein the user equipment comprises a second user equipment and wherein the processor is configured to receive the first set of timing information from a first user equipment.

20. The Access Point of claim 15, wherein the processor is configured to receive the first set of timing information from the at least one neighboring Access Point without an involvement of a user equipment.
